(19) United States
(12) Patent Application Publication
(10) Pub. No.: US 2019/0241468 A1
(43) Pub. Date: Aug. 8, 2019

(54) METHOD OF MANUFACTURING STRENGTHENED GLASS SUBSTRATE AND STRENGTHENED GLASS SUBSTRATE

(71) Applicant: SAMSUNG DISPLAY CO., LTD., Yongin-si (KR)

(72) Inventors: Seung KIM, Seongnam-si (KR); Seungho KIM, Asan-si (KR); Wonsang PARK, Yongin-si (KR); Jeongwoo PARK, Yongin-si (KR); Junehyoung PARK, Seoul (KR); Hoikwan LEE, Suwon-si (KR)

(21) Appl. No.: 16/204,315

(22) Filed: Nov. 29, 2018

(30) Foreign Application Priority Data
Feb. 7, 2018 (KR) 10-2018-0015171

(51) Int. Cl. C03C 21/00; C03C 19/00; C03C 23/00

(52) U.S. Cl. CPC C03C 21/006; C03C 21/002; C03C 2203/20; C03C 23/007; C03C 23/0075; C03C 19/00

(57) ABSTRACT

A method of manufacturing a strengthened glass substrate, the method including: thermoforming a glass substrate, wherein a surface of the glass substrate includes defective depressions generated by the thermoforming; forming a silica rich layer by adding an acid to the surface of the glass substrate including the defective depressions generated by the thermoforming; removing the silica rich layer and a portion of the defective depressions by cleaning the surface of the glass substrate on which the silica rich layer is formed with an alkali; and eliminating the remaining portion of the defective depressions by polishing the surface of the glass substrate including the remaining portion of the defective depressions.

This application claims priority to Korean Patent Application No. 10-2018-0015171, filed on Feb. 7, 2018, and all the benefits accruing therefrom under 35 U.S.C. § 119, the content of which in its entirety is incorporated herein by reference.

### BACKGROUND

### 1. Field

A method of manufacturing a strengthened glass substrate and more particularly, a method of manufacturing a strengthened glass substrate capable of reducing a polishing process time and improving the glass strength, is disclosed. A strengthened glass substrate and a display device including the strengthened glass substrate are also disclosed.

### 2. Description of the Related Art

Portable terminals such as smart phones are equipped with a front glass substrate, which is called a touch screen or a touch window, and which is used to implement the touch function of a liquid crystal display (“LCD”) panel. A front glass substrate may have a flat shape. Alternatively, three-dimensional products may include a front glass substrate in which at least one side of the front glass substrate is curved.

A curved window is used to produce curved display devices. Such a curved window may be produced by heating and pressing glass substrates together using a mold. However, due to the characteristics of the glass material, defective depressions may be generated on the surface of the glass substrate during the heating and pressing process.

### SUMMARY

Embodiments of the invention may be directed to a method of manufacturing a strengthened glass substrate capable of reducing a polishing process time and improving the glass strength and to a strengthened glass substrate prepared using the disclosed method.

According to an embodiment, a method of manufacturing a strengthened glass substrate includes: thermoforming a glass substrate, wherein a surface of the glass substrate includes defective depressions generated by the thermoforming; forming a silica rich layer by adding an acid to the surface of the glass substrate including the defective depressions generated by the thermoforming; removing the silica rich layer and a portion of the defective depressions by cleaning the surface of the glass substrate on which the silica rich layer is formed, with an alkali; and eliminating the remaining portion of the defective depressions by polishing the surface of the glass substrate including the remaining portion of the defective depressions.

The silica rich layer may be formed on the surface of the glass substrate and in the defective depressions, and the silica rich layer extends through an entire depth of the defective depressions or a through a portion of the depth of the defective depressions.

The silica rich layer may have a density which is about 5% to about 10% less than a density of a center portion of the glass substrate.

The acid may include HNO₃, HCl, H₂SO₄, or a combination thereof.

The alkali cleaning may include a NaOH solution, a KOH solution, or a combination thereof.

The method may further include, chemically strengthening the thermoformed glass substrate before forming the silica rich layer.

The chemical strengthening may include providing heat at a temperature of about 500° C. or greater.

The chemical strengthening may include providing an additive and heat at a temperature of about 400° C. or greater to about 500° C. or less.

The additive may include K₂CO₃, Na₂CO₃, KHCO₃, K₃PO₄, Na₃PO₄, K₂SO₄, Na₂SO₄, KOH, NaOH, or a combination thereof.

Polishing of the surface of the glass substrate from which the silica rich layer is removed may include mechanical polishing.

The mechanical polishing may include a grinding method.

The method may further include, adjusting a surface roughness of the glass substrate after polishing the surface of the glass substrate from which the silica rich layer is removed.

Adjusting the surface roughness may include applying a fluoric acid solution or a non-fluoric acid solution to the polished surface of the glass substrate.

According to an embodiment, a strengthened glass substrate is manufactured according to a method of an embodiment of the invention.

In a ball drop test using a test material having a thickness of 4.5 inches, the strengthened glass substrate has a height of breakage that is about three times greater than a height of breakage of a glass substrate prepared by thermoforming and only chemically strengthened.

In a ball drop test using a test material having a thickness of 4.5 inches, the strengthened glass substrate has a height of breakage that is about two times greater than a height of breakage of a glass substrate prepared by thermoforming and only polished and chemically strengthened.

The foregoing is illustrative only and is not intended to be in any way limiting. In addition to the illustrative aspects, embodiments and features described above, further aspects, embodiments and features will become apparent by reference to the drawings and the following detailed description.

### BRIEF DESCRIPTION OF THE DRAWINGS

A more complete appreciation of the other advantages and features of the invention will become more apparent by describing in detail embodiments thereof with reference to the accompanying drawings, in which:

FIG. 1 is a flowchart illustrating a method of manufacturing a strengthened glass substrate according to an embodiment;

FIG. 2 is a cross-sectional view illustrating defective depressions generated on the surface of the glass substrate;

FIG. 3 is a cross-sectional view illustrating an exemplary glass substrate according to an embodiment, and for explaining a silica-rich layer disposed on the surface of the glass substrate;

FIG. 4A is a graph illustrating the light transmittance (percentage, %) versus wavelength (nanometers, nm), of a glass substrate after chemical strengthening and before forming the silica-rich layer, according to an embodiment;

FIG. 4B is a graph illustrating the transmittance (%) versus wavelength (nm) of a chemically strengthened glass substrate after the silica-rich layer is formed thereon, according to an embodiment;

FIG. 4C is graph illustrating the transmittance (%) versus wavelength (nm), of a glass substrate after the silica-rich layer is removed;

FIG. 5 is a graph illustrating intensity (C/S) versus time (minutes, min), showing the change in hydrogen ion concentration according to the depth of the strengthened glass substrate over time as measured by dynamic secondary ion mass spectrometry (“D-SIMS”), according to an embodiment of the present invention;

FIG. 6 is a graph of surface roughness (nm) versus test sample, illustrating the surface roughness of a glass substrate according to an embodiment after removal of the silica-rich layer (Experiment) and a surface roughness of a glass substrate on which only chemical strengthening is performed (Reference); and

FIG. 7 is a graph of height (cm) versus test sample, showing the results of a ball drop test performed on a glass substrate manufactured according to Experiment 1, Experiment 2, and the Reference; and

### DETAILED DESCRIPTION

Embodiments will now be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

In the drawings, thicknesses of a plurality of layers and areas are illustrated in an enlarged manner for clarity and ease of description thereof. When a layer, area or plate is referred to as being related to another elements such as being “on” another layer, area or plate, it may be directly on the other layer, area, or plate, or intervening layers, areas, or plates may be present therebetween. Conversely, when a layer, area, or plate is referred to as being “directly on” another layer, area or plate, intervening layers, areas or plates are absent therebetween. Further when a layer, area, or plate is referred to as being related to another element such as being “below” another layer, area or plate, it may be directly below the other layer, area or plate, or intervening layers, areas, or plates may be present therebetween. Conversely, when a layer, area, or plate is referred to as being related to another element such as being “directly below” another layer, area or plate, intervening layers, areas or plates are absent therebetween.

The spatially relative terms “below,” “beneath,” “lower,” “above,” “upper” and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element is “mechanically connected” or “physically connected” to the other element, or “electrically connected” to the other element with one or more intervening elements interposed therebetween.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises,” “including,” “includes” and/or “including,” when used in this specification, specify the presence of stated features, integers, steps, operations, elements and/or components, but do not preclude the presence or addition of one or more other features, integers, steps, operations, elements, components and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of variation for the particular value as determined by one of ordinary skill in the art, considering the measurement in question and the error associated with measurement of the particular quantity (i.e., the limitations of the measurement system). For example, “about” may mean within one or more standard variations, or within ±30%, 20%, 10%, 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an idealized or excessively formal sense unless clearly defined in the present specification.

Hereinafter, a method of manufacturing a strengthened glass substrate according to an embodiment of the present invention will be described.

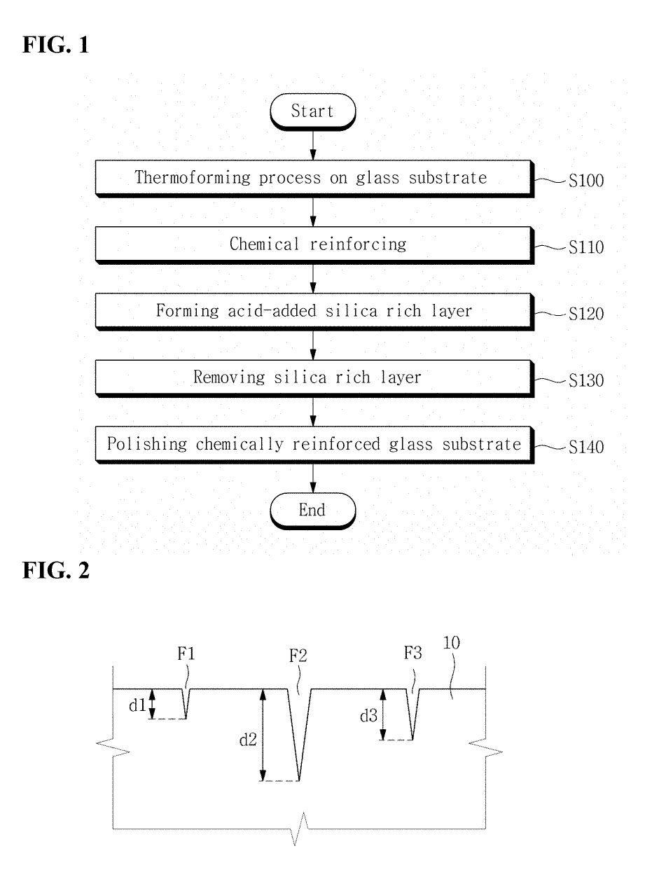

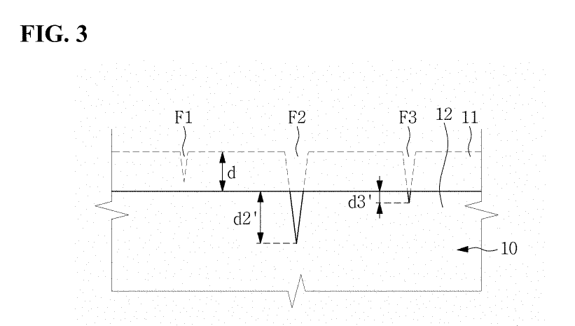

FIG. 1 is a flowchart schematically illustrating a method of manufacturing a strengthened glass substrate according to an embodiment, FIG. 2 is a cross-sectional view for explaining the generation of defective depressions on the surface of the glass substrate, and FIG. 3 is a cross-sectional view illustrating an exemplary glass substrate according to an embodiment, and for explaining a silica layer (e.g., silica-rich layer) disposed on the surface of the glass substrate.

First, as illustrated in FIG. 1, a glass substrate is thermoformed into a desired shape (S100). Before thermoforming, a process of preparing the glass substrate is carried out.

The process of preparing a glass substrate includes cutting a glass to a desired size (a cutting process), chamfering edges of the cut surface (chamfering process), and polishing the surface of a cut portion and an edge portion (cut surface polishing process). The glass substrate prepared in such a manner is then subjected to thermoforming.

In order to thermoform the glass substrate, the glass substrate is preheated, the preheated glass substrate is placed in a mold, the glass substrate placed in the mold is heated and sagged in a vacuum state to form a curved portion, and the formed glass substrate is cooled. A method of thermoforming the glass substrate is known and its detailed description is thus omitted.

The thermoforming process improves the surface compressive stress of the glass substrate, but causes the formation of defective depressions on the surface of the glass due to the compressive stress on the surface. As the thermoforming temperature rises, the number of defective depressions and the size of the defective depressions increase.

As illustrated in FIG. 2, defective depressions F1, F2, and F3 on the surface of the thermoformed glass substrate 10 are generated in a depth direction d1, d2, d3 on the surface of the glass substrate. A plurality of defective depressions may be generated, and depths d1, d2, and d3 and widths of the defective depressions may be different from each other. As used herein, the depth of the defective depression is defined with respect to the surface of the glass substrate.

Next, the thermoformed glass substrate is chemically reinforced (e.g., strengthened) (S110). Chemical strengthening of the glass substrates includes an ion exchange method.

Chemical strengthening using the ion exchange method is a method in which an alkali ion in the glass is converted into another alkali ion to form a compressive stress layer on the surface of the glass substrate. In general, the method includes the immersion of the glass substrate in a molten salt to exchange alkali ions in the glass substrate with alkali ions in the molten salt.

For example, the ion exchange method generally involves immersing the glass substrate in a molten salt to exchange alkali ions (e.g., Na⁺) in the glass substrate with alkali ions (e.g. K⁺) having a large ionic radius. This ion exchange causes a compressive stress on the surface of the glass substrate.

In an embodiment, the glass substrate to be strengthened is immersed in a potassium nitrate solution in order to replace sodium ions in the glass substrate with potassium ions from the potassium nitrate solution. In such an embodiment, the temperature and type of additive used in the ion exchange process may be changed as desired to control the depth of ion exchange between the potassium ions of the potassium nitrate solution and the sodium ions of the glass substrate.

In an exemplary embodiment, the chemical strengthening of the glass substrate may be performed at a temperature of about 500° C. or greater, or about 600° C. or greater, or about 700° C. or greater.

As another exemplary embodiment, in the case where an additive is added to the glass substrate when chemically strengthening the glass substrate, the chemical strengthening of the glass substrate may be performed at a relatively decreased temperature, for example, in a range from about 400° C. to about 500° C. The additive may include K₂CO₃, Na₂CO₃, KHCO₃, K₃PO₄, Na₃PO₄, K₂SO₄, Na₂SO₄, KOH, NaOH, or a combination thereof.

A silica layer (e.g., a silica-rich layer) is formed by adding acid to the chemically strengthened glass substrate (S120). In such an embodiment, the acid may include HNO₃, HCl, H₂SO₄, or a combination thereof.

In an exemplary embodiment, the silica-rich layer is formed by adding an acid, for example, nitric acid, to the surface of the glass substrate having defective depressions that are generated during the thermoforming and chemical strengthening processes.

In such an embodiment, the process by which the silica-rich layer is formed is illustrated by Chemical Equation 1 and Chemical Equation 2 below.

Si—O—K+H⁺(HNO₃)+OH⁻(H₂O)→Si—OH+K⁺+OH⁻(Ion exchange) Chemical Equation 1

Si—OH+Si—OH→Si—O—Si+H₂O (Si-rich layer) Chemical Equation 2

Referring to Chemical Equation 1 and Chemical Equation 2, when nitric acid is added to the glass substrate, K⁺ of Si—O—K and H⁻of nitric acid are ion-exchanged to form Si—OH, and two molecules of Si—OH are combined to form Si—O—Si, and thereby the silica-rich layer is formed.

As illustrated in FIG. 3, the silica-rich layer 11 is formed on the surface of the glass substrate 10 by this chemical strengthening process. In addition, the silica-rich layer 11 formed by such a chemical strengthening process has a decreased density as compared to a center layer 12 of the glass substrate. For example, the silica-rich layer 11 has a density which is about 5% to about 10% less than the density of the center layer 12 of the glass substrate.

The silica-rich layer 11 is formed to have a constant depth d (e.g. thickness) on the surface of the glass substrate 10, as measured from the surface of the glass substrate to an upper surface of the silica-rich layer 11. Further, the silica-rich layer 11 is evenly distributed in the defective depressions (e.g., within the spaces defined by the defective depressions).

The silica-rich layer 11 is formed on the surface of the glass substrate 10 and in the defective depressions. The silica layer extends through an entire depth of the defective depression or through only a portion of the depth of the defective depression. For example, the silica layer may be in all of the space defined by a defective depression or in only a portion of the space defined by the defective depression.

The method further includes removing the silica layer and a portion of the defective depressions by cleaning the surface of the glass substrate on which the silica layer is formed, with an alkali (S130). The alkali used for cleaning the surface of the glass substrate may include NaOH, KOH, or a combination of NaOH and KOH. In particular, the alkali includes a NaOH solution, a KOH solution, or a combination thereof,

The silica-rich layer is removed from the glass substrate with the silica-rich layer using an alkali aqueous solution such as sodium hydroxide, for example.

The principle of removing the silica-rich layer may be explained by Chemical Equation 3.

Si—O—Si+OH⁻(NaOH)→Si—O⁻ (network structure destroyed)+HO—Si Chemical Equation 3

Referring to Chemical Equation 3, sodium hydroxide is added to the glass substrate on which the silica-rich layer is formed, whereby the network structure of Si—O—Si is destroyed to form Si—O⁻ and HO—Si.

After removing the silica-rich layer, the chemically-reinforced, neutralized glass substrate is polished (S140).

The neutralized glass substrate is subjected to mechanical polishing, and excludes chemical polishing. The mechanical polishing may be performed by a grinding method, for example, and accordingly, the remaining defective depressions may be eliminated.

After polishing, the surface roughness of the glass substrate may be adjusted by treating the surface of the glass substrate with a fluoric acid solution or a non-fluoric acid solution. Other components, i.e., acids, may optionally be present in the solutions.

A washing step using a distilled water may be further included between any or each of the method steps. The distilled water used in such an embodiment may be at a temperature of about 40° C., and the washing time may be in a range from about 1 minute to about 5 minutes.

Through the method of manufacturing a strengthened glass substrate according to an embodiment, the time for polishing the defective depressions generated on the surface of the glass substrate by thermoforming and strengthening of the glass substrate, may be reduced.

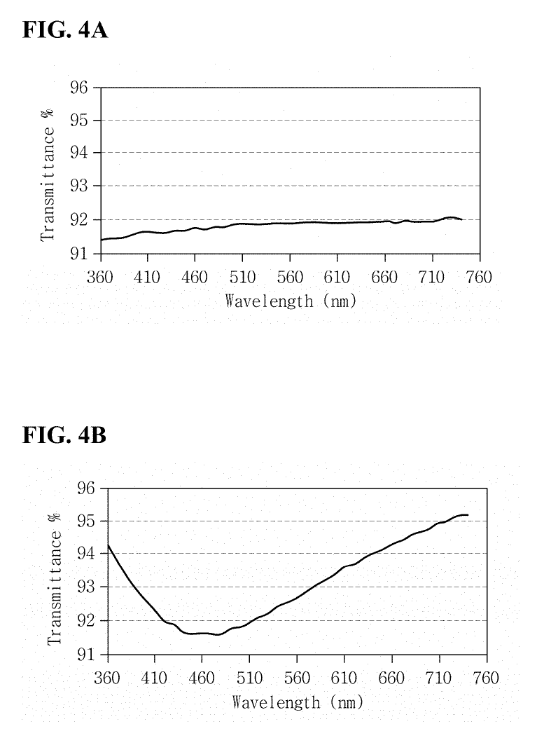

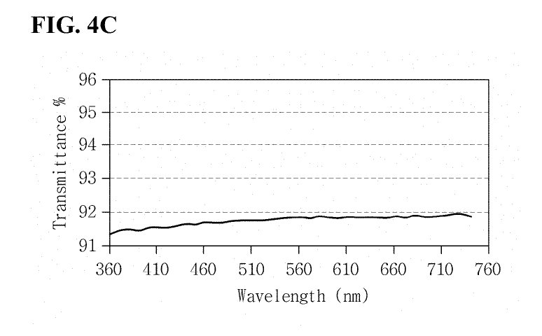

FIGS. 4A to 4C are graphs illustrating the transmittance of a glass substrate according to an embodiment, for each wavelength, as measured at different points during the implementation of the exemplary method.

FIG. 44A is a graph illustrating the light transmittance, for each wavelength of visible light, of a glass substrate after the chemical reinforcing/strengthening step (S110) and before the forming of the silica-rich layer. FIG. 4B is a graph illustrating the light transmittance, for each wavelength of the visible light, of a chemically strengthened glass substrate after the silica-rich layer is formed thereon (S12) and before the silica-rich layer is removed. Finally, FIG. 4C is a graph illustrating the light transmittance, for each wavelength of the visible light, of a glass substrate after the silica-rich layer is removed (S130).

Referring to FIGS. 4A-4C, it may be appreciated that the silica-rich layer is cleanly removed based on the fact that the transmittance before the formation of the silica-rich layer and the transmittance after the removal of the silica-rich layer are substantially similar to each other.

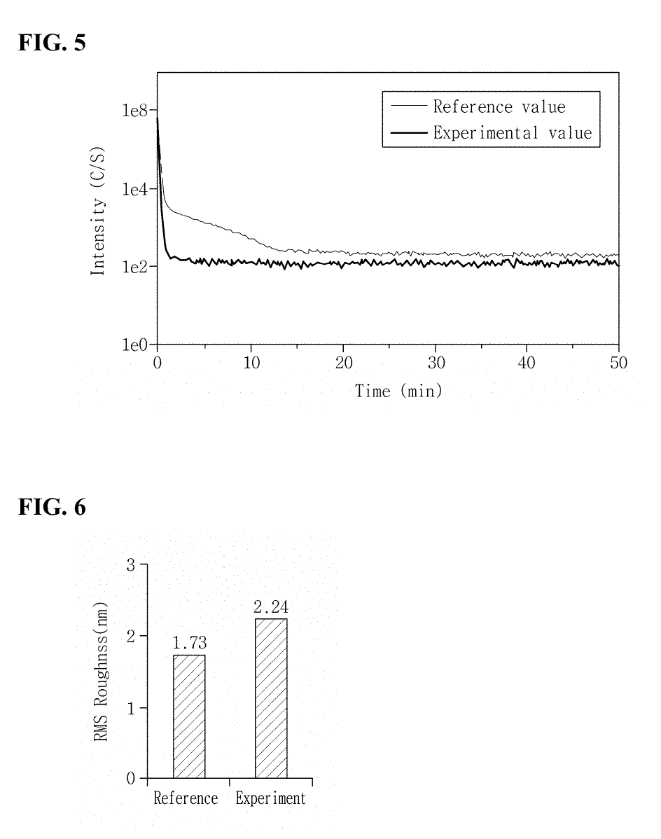

FIG. 5 is a graph further illustrating the characteristics of a strengthened glass substrate according to an embodiment of the present invention.

As illustrated in FIG. 5, the hydrogen ion concentration according to the depth of the strengthened glass substrate may be identified by dynamic secondary ion mass spectrometry (“D-SIMS”) equipment.

The D-SIMS equipment is a device that analyzes the depth distribution of trace component by colliding a primary ion beam with the surface of a solid sample to analyze the mass of secondary ions that are sputtered from the sample surface. The D-SIMS equipment provides a measure of the hydrogen ion concentration of an object over time.

Referring to FIG. 5, the x-axis represents the time in minutes. The longer the time, the deeper the depth of the glass substrate being measured, so the time axis may be understood to correspond to the depth of the glass substrate. In other words, FIG. 5 is a graph illustrating the relative concentration of hydrogen ions according to depth.

In FIG. 5, the reference value represents the amount of hydrogen ions according to the depth of a glass substrate that has undergone only chemical strengthening.

In FIG. 5, the experimental value represents the amount of hydrogen ions according to the depth after removing the silica-rich layer from the chemically strengthened glass substrate.

Referring to FIG. 5, in the glass substrate on which only chemical strengthening is performed, it may be appreciated that the concentration of hydrogen ions rapidly decreases to the depth of the glass substrate corresponding to the measurement time of 10 minutes, and after the depth of the glass substrate corresponding to the measurement time of 10 minutes, it becomes constant at an arbitrary value of 1×10².

On the other hand, after removing the silica-rich layer from the chemically strengthened glass substrate, it may be appreciated that the concentration of hydrogen ions substantially similar to the arbitrary value 1×10² also appears from the surface of the glass substrate. From the above, it may be appreciated that the silica-rich layer has been removed.

FIG. 6 is a graph illustrating the surface roughness of a glass substrate according to an embodiment.

In FIG. 6, the Reference denotes a surface roughness of a glass substrate on which only chemical strengthening is performed, and the Experiment denotes a surface roughness of a glass substrate after chemical strengthening, forming of the silica-rich layer, and removing the silica-rich layer.

The surface roughness usable for general display devices is about 3 nm or less, and thus a surface roughness of about 2.24 nm of the glass substrate manufactured according to an exemplary embodiment is a usable level for display devices.

In addition, it is possible to control to have a better roughness through a surface treatment using a fluoric acid-based solution or a non-fluoric acid-based solution.

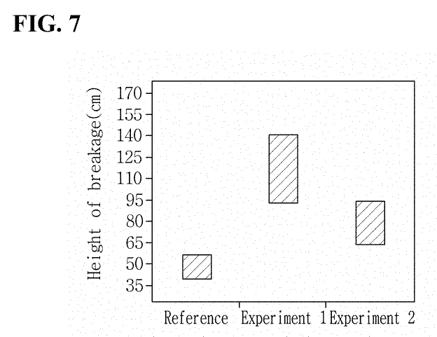

FIG. 7 is a graph showing the result of a ball drop test on a glass substrate manufactured according to an embodiment of the present invention.

The ball drop test is conducted using a 4.5 inch glass substrate and a 130.5 gram steel ball, and under ambient conditions (e.g., room temperature).

The 4.5 inch glass substrate, as test material, is placed on a support base supporting all four sides of the glass substrate, and having a hole at the center portion thereof through which the ball is dropped onto the surface of the glass substrate. The steel ball was then dropped, and the height at which the tested glass substrate was broken was recorded. Respective surfaces of the support base and the glass substrate are in contact with each other by about 5 mm in length.

Although not shown in the graph, the result of the ball drop test of the glass substrate before chemical strengthening was about 20 centimeters (cm) maximum.

The Reference is a glass substrate on which only chemical strengthening is performed, Experiment 1 is a glass substrate in which chemical strengthening is performed, the silica-rich layer is formed and then removed, and polishing is performed, and Experiment 2 is a glass substrate in which the chemical strengthening is performed after the polishing (i.e., instead of before the silica-rich layer is formed and then removed). The height of breakage for the Reference (the case of chemical strengthening only) was in the range from about 40 cm to about 55 cm. The result of the ball drop test for the glass substrate of Experiment 1, in which chemical strengthening is performed, the silica-rich layer is formed and then removed, and polishing is performed according to an embodiment, was in the range from about 95 cm to about 140 cm. The result of the ball drop test for the glass substrate of Experiment 2, in which chemical strengthening is performed after polishing, is in the range from about 65 cm to about 95 cm.

That is, based on the result of the ball drop test, the glass substrate in which chemical strengthening is performed, the silica-rich layer is formed and then removed, and polishing is performed according to an embodiment (Experiment 1), has a height of breakage that is at least about three times greater than a height of breakage of the glass substrate that is only chemically strengthened, and has a height of breakage that is at least two times greater than a height of breakage of the glass substrate that is chemically strengthened after polishing.

As set forth hereinabove, the method of manufacturing the strengthened glass substrate and the method of manufacturing the display device including the strengthened glass substrate may provide the following effects.

It is possible to reduce the amount of time for polishing the glass substrate to eliminate defective depressions which have been generated during a thermoforming process. In addition, the strength of the glass substrate may also be improved.

While the present invention has been illustrated and described with reference to the embodiments thereof, it will be apparent to those of ordinary skill in the art that various changes in form and detail may be formed thereto without departing from the spirit and scope of the present invention.

What is claimed is:

1. A method of manufacturing a strengthened glass substrate, the method comprising:
thermoforming a glass substrate, wherein a surface of the glass substrate comprises defective depressions generated by the thermoforming;
forming a silica rich layer by adding an acid to the surface of the glass substrate comprising the defective depressions generated by the thermoforming;
removing the silica rich layer and at least a portion of the defective depressions by cleaning the surface of the glass substrate on which the silica rich layer is formed, with an alkali; and
eliminating a remaining portion of the defective depressions by polishing the surface of the glass substrate comprising the remaining portion of the defective depressions.

2. The method of claim 1, wherein the silica rich layer is formed on the surface of the glass substrate and in the defective depressions, and the silica rich layer extends through an entire depth of the defective depressions or through a portion of the depth of the defective depressions.

3. The method of claim 1, wherein the silica rich layer has a density which is about 5% to about 10% less than a density of a center portion of the glass substrate.

4. The method of claim 1, wherein the acid comprises HNO₃, HCl, H₂SO₄, or a combination thereof.

5. The method of claim 1, wherein the alkali comprises a NaOH solution, a KOH solution, or a combination thereof.

6. The method of claim 1, further comprising, chemically strengthening the thermoformed glass substrate before the forming of the silica rich layer.

7. The method of claim 6, wherein the chemical strengthening comprises providing heat at a temperature of about 500° C. or greater.

8. The method of claim 6, wherein the chemical strengthening comprises providing an additive and heat at a temperature of about 400° C. or greater to about 500° C. or less.

9. The method of claim 8, wherein the additive comprises K₂CO₃, Na₂CO₃, KHCO₃, K₃PO₄, Na₃PO₄, K₂SO₄, Na₂SO₄, KOH, NaOH, or a combination thereof.

10. The method of claim 1, wherein the polishing of the surface of the glass substrate from which the silica rich layer is removed comprises mechanical polishing.

11. The method of claim 10, wherein the mechanical polishing comprises a grinding method.

12. The method of claim 1, further comprising, adjusting a surface roughness of the glass substrate after polishing the surface of the glass substrate from which the silica rich layer is removed.

13. The method of claim 12, wherein the adjusting of the surface roughness comprises applying a fluoric acid solution or a non-fluoric acid solution to the polished surface of the glass substrate.

14. The method of claim 1, wherein the silica rich layer comprises Si—O—Si.

15. A strengthened glass substrate, the strengthened glass substrate manufactured by the method of claim 1.

16. The strengthened glass substrate of claim 15, wherein as measured in a ball drop test using a test material having a thickness of 4.5 inches, the strengthened glass substrate has a height of breakage that is about three times greater than a height of breakage of a glass substrate prepared by thermoforming and only chemically strengthened.

17. The strengthened glass substrate of claim 15, wherein as measured in a ball drop test using a test material having a thickness of 4.5 inches, the strengthened glass substrate has a height of breakage that is about two times greater than a height of breakage of a glass substrate prepared by thermoforming and chemically strengthened after polishing.

18. A display device comprising, a touch screen comprising the strengthened glass substrate of claim 15.
